(19) United States
(12) Patent Application Publication
(10) Pub. No.: US 2012/0188623 A1
(43) Pub. Date: Jul. 26, 2012

(54) SCANNING IMAGE DISPLAY DEVICE AND METHOD OF CONTROLLING THE SAME

(75) Inventor: Hiroshi INOUE, Nissin-shi (JP)

(73) Assignee: BROTHER KOGYO KABUSHIKI KAISHA, Aichi-ken (JP)

(21) Appl. No.: 13/356,051

(22) Filed: Jan. 23, 2012

(30) Foreign Application Priority Data
Jan. 24, 2011 (JP) 2011-012169

(51) Int. Cl. G02B 26/10

(52) U.S. Cl. 359/197.1

(57) ABSTRACT

A scanning image display device includes a laser source, a scanning section, a light detecting section, and a current control section. The laser source configured to emit laser light. The scanning section configured to scan the laser light within a scanning area. The light detecting section configured to detect the laser light. The a current control section configured to control a bias current and a modulated current which changes in accordance with an image signal and to adjust a modulation width of the modulated current to set a minimum value of the laser light emitted by the light source as a first target value.

### CROSS-REFERENCE TO RELATED APPLICATION

This application claims priority from JP2011-012169, filed on Jan. 24, 2011, the content of which is hereby incorporated by reference.

### BACKGROUND OF THE DISCLOSURE

1. Field of the Disclosure

The present disclosure relates to a scanning image display device and a method of controlling the same. The scanning image display scans laser light emitted from a light source section which includes a semiconductor laser as a light source and projects the scanned laser light on a projection target.

2. Description of the Related Art

A scanning image display device which includes a light source section, a scanning section and a projecting section has been proposed. The light source section emits laser light of intensity corresponding to an image signal. The scanning section two-dimensionally scans the laser light emitted from the light source section. The projecting section projects laser light scanned by the scanning section on a projection target and displays an image. Examples of the scanning image display device include a retinal scanning image display device of which projection target is a retina of a viewer's eye and an optical scanning display device of which projection target is a screen.

In such a scanning image display device, a semiconductor laser (i.e., a laser diode) may be used as a light source which constitutes the light source section. The semiconductor laser (i.e., a laser diode) emits substantially no light until a value of supplied current reaches a specific threshold current value. Thus, a bias current is supplied to the light source from the viewpoint of improving response of the light source section. That is, in a system in which an image is displayed with the laser light emitted from the light source section, a driving current corresponding to the image signal is superimposed on the bias current and is supplied to the light source.

The characteristics of the above-described light source change with, for example, heat generated during emission of the laser light, changes in the ambient temperature, and age deterioration. Changes in the characteristics of the light source include changes in a threshold current value of the light source. Changes in the threshold current value of the light source cause defects of, for example, unstable brightness of the displayed image.

Therefore, the Automatic Power Control (APC) in which optical output of the light source section is controlled automatically has been proposed as a technique to keep the optical output constant. With the APC the bias current supplied to the light source is controlled such that the optical output of the light source is a predetermined value with reference to the optical output of the light source detected by, for example, a photo diode.

### SUMMARY OF THE DISCLOSURE

In a case in which the APC is implemented in a scanning image display device, the following problems will be caused. In a scanning image display device, there exist an image area and a non-image area as scanning areas scanned with laser light by a scanning section. An image is displayed in the image area. The non-image area, in which no image is formed, is defined outside the image area. In the non-image area, only the bias current is supplied to the light source. In the image area, a driving current (i.e., a modulated current) of the size corresponding to the image signal is superimposed on the bias current and is supplied to the light source. Thus, when the scanning position of the laser light is located in the non-image area, the light source has a certain laser light output (i.e., a brightness level of a displayed image) with the supplied bias current. Brightness of the displayed image in the non-image area corresponds to the minimum value of the displayed image (“black level”). An image is displayed by the supplied driving current (i.e., the modulated current) of the size corresponding to the image signal on the basis of the state of the black level. The APC is only implemented through the adjustment of the bias current supplied to the light source in a state in which the scanning position of the laser light is located in the non-image area.

When the value of bias current supplied to the light source undergoes fluctuations with the APC in response to, for example, change in air temperature, the black level is changed. Changes in the black level due to changes in air temperature or other factors cause deterioration in quality of the displayed image. Deterioration in image quality includes unstable brightness of the displayed image and lowered contrast in the image area.

An object of the present disclosure is to provide a scanning image display device capable of reducing changes in black level through the adjustment of a modulation width of the modulated current.

An aspect of the present disclosure is a scanning image display device A scanning image display device includes a laser source, a scanning section, a light detecting section, and a current control section. The laser source configured to emit laser light. The scanning section configured to scan the laser light within a scanning area. The light detecting section configured to detect the laser light. The a current control section configured to control a bias current and a modulated current which changes in accordance with an image signal and to adjust a modulation width of the modulated current to set a minimum value of the laser light emitted by the light source as a first target value. The bias current is supplied to the laser source based on the laser light detected by the light detecting section. The modulated current changes in accordance with an image signal.

Another aspect of the present disclosure is a method of controlling a current supplied to a laser source configured to emit laser light in a scanning image display device. The method adjusts a modulation width of a modulated current to set a minimum value of the laser light emitted from the laser source as a first target value when the scanning position is outside an image area, the modulated current changes in accordance with an image signal. And the method controls a bias current and the modulated current, the modulated current has the adjusted modulation width, and the bias current is supplied to the laser source based on laser light detected by the light detecting section.

Another aspect of the present disclosure is a scanning image display device including a laser source, a scanner, a light detector, a position detector, a memory, and a processor. The laser source is configured to emit laser light. The scanner is configured to scan the laser light within a scanning area. The light detector is configured to detect the laser light. The position detector is configured to detect a scanning position of laser light. The memory is configured to store computer readable programs. The processor is configured to execute the computer readable the computer readable programs to provide an adjustment unit and a current control unit. The adjustment unit is configured to adjust a modulation width of a modulated current to set a minimum value of the laser light emitted from the laser source as a first target value, the modulated current changes in accordance with an image signal. The current control unit is configured to control a bias current and the modulated current, the modulated current has the modulation width adjusted in the adjustment instruction, and the bias current is supplied to the laser source based on laser light output detected by the light detector.

Another aspect of the present disclosure is a scanning image display device including a laser source, a scanner, a light detector, a position detector, and a circuit. The laser source is configured to emit laser light. The scanner is configured to scan the laser light within a scanning area. The light detector is configured to detect the laser light. The position detector is configured to detect a scanning position of laser light. The circuit provide functional units. The functional unit includes determining the scanning position, adjusting a modulation width of a modulated current to set a minimum value of the laser light emitted from the laser source as a first target value when the scanning position is outside an image area, the modulated current changes in accordance with an image signal, and the image area is the area in which a displayed image is formed within a scanning area, and controlling a bias current and the modulated current, the modulated current has the adjusted modulation width, and the bias current is supplied to the laser source based on laser light output detected by the light detector.

### BRIEF DESCRIPTION OF THE DRAWINGS

For a more complete understanding of the invention, the needs satisfied thereby, and the objects, features, and advantages thereof, reference now is made to the following description taken in connection with the accompanying drawings.

FIG. 1 illustrates a block diagram of an example of components of a scanning image display device.

FIG. 2A illustrates a deflection angle of a deflection element 34a (i.e., scanning position in a vertical direction).

FIG. 2B illustrates a deflection angle of a deflection element 32a (i.e., scanning position in a horizontal direction).

FIG. 2C illustrates an image area and a non-image area in the horizontal direction and the vertical direction.

FIG. 3 illustrates a relationship between a current value and a light output in a light source section.

FIG. 4 illustrates changes in the relationship between the current value and the light output in the light source section.

FIG. 5 is a block diagram illustrating a control configuration.

FIG. 6 is a flowchart illustrating an example of the entire current control.

FIG. 7 is a flowchart illustrating an example of the current control in each laser.

FIG. 8 is a flowchart illustrating another example of the entire current control.

FIG. 9A illustrates a position of a BD sensor relative to a scanning lens and a horizontal scanning section.

FIG. 9B illustrates a time variation in a scanning position of the horizontal scanning section.

FIG. 9C illustrates a time variation in an input current value supplied to a semiconductor laser.

FIG. 9D illustrates a time variation in a BD signal generated by the BD sensor.

FIG. 10 illustrates a flowchart illustrating another example of the current control in each laser.

FIG. 11 illustrates an explanatory view illustrating an external appearance of a retinal scanning display according to an embodiment.

### DESCRIPTION OF THE PREFERRED EMBODIMENTS

In the present disclosure, the maximum value and the minimum value of the optical output of a semiconductor laser as a light source with characteristics which change in response to, for example, temperature changes, is controlled automatically to keep predetermined values. Changes in a black level can be prevented and thereby image quality is stabilized by appropriately selecting the timing at which each value is controlled.

An embodiment of the present disclosure described below relates to a case in which the present disclosure is applied to a Retinal Scanning Display (“RSD”) which is an example of scanning image display devices. The present disclosure is not limited to the RSD which is a retinal scanning image display device but also applicable to other scanning image display devices, such as an optical scanning display device (i.e., a laser display) of which projection target is a screen.

### Structure of the RSD

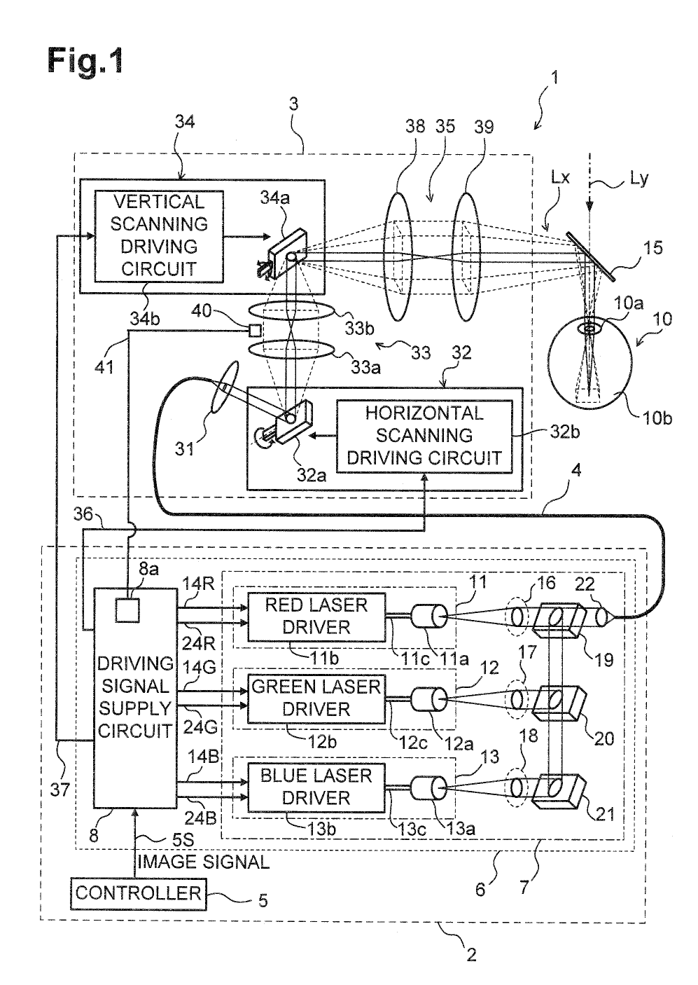

As illustrated in FIG. 1, in an RSD 1 according to the present embodiment, a projection target of the laser light is a retina 10b of at least one of the eyes 10 of a viewer. The laser light as a light beam is scanned by a scanning section. A projecting section lets the scanned laser light enter the retina 10b so that the viewer recognizes the image. In particular, the RSD 1 is a retinal scanning image display device in which weak light is scanned at high speed and is projected on the viewer's retina 10b and thereby lets the viewer recognize a residual image of the scanned on the retina 10b.

As illustrated in FIG. 1, the RSD 1 includes a control unit 2 and a projection unit 3. The control unit 2 emits laser light of intensity in accordance with an image signal as imagewise light. The imagewise light emitted from the control unit 2 is transmitted to the projection unit 3 via an optical fiber cable 4.

The control unit 2 includes an image data storage and generates an image signal with reference to content data stored in therein. The image data storage is incorporated into the controller 5. The control unit 2 emits, to the optical fiber cable 4, laser light of intensity in accordance with the generated image signal as imagewise light.

The projection unit 3 scans the imagewise light transmitted via the optical fiber cable 4 so that the viewer can recognize the imagewise light as a displayed image. The projection unit 3 two-dimensionally scans the imagewise light of which intensity has been modulated for each color of red (R), green (G) and blue (B) in the control unit 2. The two-dimensionally scanned imagewise light enters the viewer's eyes 10.

Electrical and optical configurations of the RSD 1 will be described in detail. The control unit 2 includes a controller 5 and a light source unit 6. The light source unit 6 includes a light source section 7 and a driving signal supply circuit 8.

The controller 5 controls components of the RSD 1 comprehensively. The controller 5 controls the RSD 1 by performing predetermined processes in accordance with a previously stored control program. The controller 5 includes various functional components, such as a CPU, flash memory, RAM, VRAM and a plurality of I/O interfaces which are connected by a data communication bus. The controller 5 transmits and receives data via the bus.

Various pieces of image data, such as image data supplied from unillustrated external equipment connected via, for example, an I/O terminal and image data on the basis of previously stored content data are input to the controller 5. The controller 5 generates an image signal 5S with reference to the input image data. The image signal 5S generated by the controller 5 is sent to the driving signal supply circuit 8. That is, the controller 5 lets the light source section 7 emit laser light of intensity in accordance with the image signal 5S.

The driving signal supply circuit 8 functions as a driving signal generating section which generates a driving signal with reference to the image signal 5S. The driving signal supply circuit 8 generates, with reference to the image signal 5S, a signal for each pixel as a factor for the generation of the displayed image. The driving signal supply circuit 8 includes a position determination circuit 8a (see below for the detail).

The light source section 7 emits laser light of intensity in accordance with the driving signal generated by the driving signal supply circuit 8. The light source section 7 includes a red laser section 11 which generates and emits red laser light, a green laser section 12 which generates and emits green laser light and a blue laser section 13 which generates and emits blue laser light.

The laser sections of each color 11, 12 and 13 include lasers 11a, 12a and 13a and laser drivers 11b, 12b and 13b, respectively. The lasers 11a, 12a and 13a are light sources which generate laser light of each color. The laser drivers 11b, 12b and 13b are light source driving sections which drive the lasers 11a, 12a and 13a. The lasers of each color 11a, 12a and 13a are semiconductor lasers (i.e., laser diodes). At least one of the lasers of each color 11a, 12a and 13a, especially the green laser 12a, may be, for example, a second harmonic generation (SHG) laser which can generate second harmonic laser by an SHG element which is a wavelength conversion element. The lasers of each color 11a, 12a and 13a, and the laser drivers 11b, 12b and 13b of corresponding color are connected via driving lines 11c, 12c and 13c, respectively.

The laser drivers of each color 11b, 12b and 13b each supplies a driving current to the corresponding laser 11a, 12a and 13a in accordance with the drive signal input from the drive signal supply circuit 8. Then the lasers 11a, 12a and 13a each emits laser light of intensity modulated in accordance with the driving current supplied from the corresponding laser drivers 11b, 12b and 13b. Therefore, the red laser section 11 lets the laser driver 11b drive the laser 11a in accordance with a driving signal 14R supplied from the driving signal supply circuit 8, and emits red laser light. The green laser section 12 lets the laser driver 12b drive the laser 12a in accordance with a driving signal 14G supplied from the driving signal supply circuit 8, and emits green laser light. The blue laser section 13 lets the laser driver 13b drive the laser 13a in accordance with a driving signal 14B supplied from the driving signal supply circuit 8, and emits blue laser light.

In the present embodiment, the driving currents supplied to the lasers 11a, 12a and 13a correspond to modulated currents which fluctuate in accordance with the image signal 5S. The laser drivers of each color 11b, 12b and 13b drive the lasers of each color 11a, 12a and 13a by sequentially supplying, on the pixel basis, the lasers of each color 11a, 12a and 13a with the modulated current of the size in accordance with the image signal 5S. Intensity of the laser light emitted from the lasers of each color 11a, 12a and 13a is modulated through modulation of the modulated current supplied to the lasers of each color 11a, 12a and 13a.

The drive signal supply circuit 8 generates bias current supply signals 24R, 24G and 24B for supplying the bias current to the lasers of each color 11a, 12a and 13a. The laser drivers of each color 11b, 12b and 13b supply the bias current to the corresponding lasers 11a, 12a and 13a in accordance with the bias current supply signal input from the drive signal supply circuit 8. Since the bias current causes the lasers of each color 11a, 12a and 13a which constitute the light source section 7 to be in a standby state, the response of the light source section 7 becomes quicker. The bias current supply signals 24R, 24G and 24B corresponding to each color may be superimposed on the driving signals 14R, 14G and 14B of corresponding colors and may be output from the drive signal supply circuit 8.

In the RSD 1 of the present embodiment, the drive signal supply circuit 8 functions as a current supply section which supplies the light source section 7 with the modulated current as a current for displaying an image in accordance with the image signal 5S and with the bias current for letting the light source section 7 be in a standby state. That is, the drive signal supply circuit 8 generates the driving signals 14R, 14G and 14B and the bias current supply signals 24R, 24G and 24B to be transmitted to the laser drivers of each color 11b, 12b and 13b in order to let the laser drivers of each color 11b, 12b and 13b supply the lasers of each color 11a, 12a and 13a with the modulated current and the bias current.

The light source section 7 multiplexes the laser light emitted by the laser sections of each color 11, 12 and 13. The multiplexed laser light is output to the optical fiber cable 4. The light source section 7 includes collimating optical systems 16, 17 and 18, dichroic mirrors 19, 20 and 21 and a coupling optical system 22.

The laser light of each color emitted from the laser sections of each color 11, 12 and 13 is collimated by the collimating optical systems 16, 17 and 18, respectively. The collimated laser light of each color enter the corresponding the dichroic mirrors 19, 20 and 21. Each of the laser light of red, green and blue which enters the corresponding dichroic mirrors 19, 20 or 21 are selectively reflected or transmitted regarding the wavelength and then reaches the coupling optical system 22. The laser light of three colors is multiplexed and condensed by the coupling optical system 22. The condensed laser light enters the optical fiber cable 4.

The laser light of each color which enters the optical fiber cable 4 from the light source section 7 is the multiplexed, intensity-modulated laser light of each color. The configuration of the optical system which lets the laser light from the laser sections of each color 11, 12 and 13 be emitted as the light emitted from the light source section 7 is not particularly limited; any configurations capable of selectively reflecting or transmitting the laser light of each color emitted from the laser sections of each color 11, 12 and 13 regarding the wavelength may be employed.

As described above, the light source section 7 emits the laser light of intensity in accordance with the image signal 5S input from the controller 5. In the present embodiment, the light source section 7 includes three semiconductor lasers which emit the laser light of different colors: a laser 11a which emits red laser light; a laser 12a which emits green laser light; and a laser 13a which emits blue laser light.

The projection unit 3 is located between the light source section 7 and the viewer's eyes 10 in the RSD 1. The projection unit 3 includes a collimating optical system 31, a horizontal scanning section 32, a first relay optical system 33, a vertical scanning section 34 and a second relay optical system 35.

The collimating optical system 31 collimates the laser light emitted from the optical fiber cable 4. The horizontal scanning section 32 reciprocatingly scans the collimated laser light in a horizontal direction to form an image to be displayed. The horizontal direction is an example of a main-scanning direction in the present embodiment. The first relay optical system 33 includes scanning lenses 33a and 33b and a beam detection (BD) sensor 40. The first relay optical system is provided between the horizontal scanning section 32 and the vertical scanning section 34. The first relay optical system 33 relays the laser light between the horizontal scanning section 32 and the vertical scanning section 34.

The vertical scanning section 34 scans, in a vertical direction, the laser light which has been scanned in the horizontal direction by the horizontal scanning section 32. The vertical direction, which is perpendicular to the horizontal direction, is an example of a sub-scanning direction in the present embodiment. The second relay optical system 35 lets the laser light which has been scanned in the horizontal direction by the horizontal scanning section 32 and in the vertical direction by the vertical scanning section 34 be emitted outside the projection unit 3.

The horizontal scanning section 32 and the vertical scanning section 34 are light scanning devices and the first relay optical system 33 is an optical system which scan the laser light emitted from the optical fiber cable 4 in the horizontal and vertical directions to form a scanned light beam in order to let the laser light be projectable as an image on the viewer's retina 10b. Thus, in the present embodiment, the configuration including the horizontal scanning section 32 and the vertical scanning section 34 functions as a scanning section which two-dimensionally scans the laser light emitted from the light source section 7. In the following description, the structure including the horizontal scanning section 32 and the vertical scanning section 34 will be collectively called as the “scanning section”.

The horizontal scanning section 32 functions, in the scanning section, as a high-speed scanner which scans the laser light at high speed with respect to the vertical scanning section 34. The horizontal scanning section 32 includes a resonant deflection element 32a and a horizontal scanning driving circuit 32b. The deflection element 32a includes a deflection surface (i.e., a reflective surface) on which the laser light is scanned in the horizontal direction. The horizontal scanning driving circuit 32b generates a driving signal which lets the deflection element 32a resonate and lets the deflection surface of the deflection element 32a fluctuate. The horizontal scanning driving circuit 32b generates the driving signal for the deflection element 32a in accordance with a horizontal driving signal 36 input from the driving signal supply circuit 8.

The vertical scanning section 34 functions, in the scanning section, as a low-speed scanner which scans the laser light at low speed with respect to the horizontal scanning section 32. The vertical scanning section 34 includes a nonresonant deflection element 34a and a vertical scanning driving circuit 34b. The deflection element 34a includes a deflection surface (i.e., a reflective surface) on which the laser light is scanned in the vertical direction. The vertical scanning driving circuit 34b generates a driving signal which lets the deflection surface of the deflection element 34a fluctuate in a nonresonant state. The vertical scanning driving circuit 34b generates the driving signal for the deflection element 34a with reference to a vertical driving signal 37 input from the driving signal supply circuit 8.

The vertical scanning section 34 scans each frame of the image to be displayed with image forming laser light in the vertical direction from the first horizontal scanning line toward the last horizontal scanning line. In this manner, a two-dimensionally scanned image is formed. The term “horizontal scanning line” herein means one scanning event in the horizontal direction by the horizontal scanning section 32. Since the deflection element 32a fluctuates, scanning in the horizontal direction includes scanning in both scanning directions: one direction (i.e., an outgoing direction) and another direction (i.e., a return direction). Here, the horizontal scanning line may mean both one-direction scanning and both-direction scanning: in the one-direction scanning, either of the outgoing direction or the return direction is used for image formation; and in the both-direction scanning, both the outgoing direction and the return direction are used for image formation. The deflection elements 32a and 34a included in the scanning section are, for example, galvanomirrors. The deflection elements 32a and 34a are driven by, for example, the following drive systems; the piezoelectric drive system, the electromagnetism drive system and the electrostatic drive system.

The first relay optical system 33 includes two scanning lens 33a and 33b. Both scanning lens 33a and 33b have positive refractivity. The first relay optical system 33 converges, on the deflection surface of the deflection element 34a, the laser light which has been scanned in the horizontal direction by the deflection surface of the deflection element 32a. The laser light converged on the deflection surface of the deflection element 34a is then scanned in the vertical direction by the deflection surface of the deflection element 34a, whereby imagewise light Lx is produced. In the RSD 1, positions of the horizontal scanning section 32 and the vertical scanning section 34 may be inverted; in that case, the laser light is scanned in the vertical direction by the vertical scanning section 34 and then scanned in the horizontal direction by the horizontal scanning section 32. A two-dimensional deflection element which performs both the horizontal scanning and the vertical scanning may be used instead of the deflection element 32a and the deflection element 34a.

The first relay optical system 33 includes a BD sensor 40 as an example of a position detector. The BD sensor 40 is located between the scanning lens 33a and 33b. Specifically, the BD sensor 40 is located at a position at which it does not interfere with the image forming laser light in the first relay optical system 33. For example, on the entire scanning area of the laser light by the scanning section, the BD sensor 40 is located at a predetermined position in a non-image area. The non-image area is outside an image area in which a displayed image is formed. The BD sensor 40 is configured to detect the laser light. The BD sensor outputs a current in accordance with intensity and timing of the received light as a BD signal 41. The BD signal 41 is input to the position determination circuit 8a within the driving signal supply circuit 8. Based on the BD signal 41, scanning timing of the laser light by the scanning section is detected. In other word, the position determination circuit 8a receives the BD signal 41 as an input from the BD sensor 40. Then, the position determination circuit 8a determines whether the scanning position is within the image area based on the BD signal 41. Then, using the BD sensor 40, emission timing of the laser light is adjusted.

The second relay optical system 35 includes two serially arranged lens systems 38 and 39 of positive refractivity. The laser light scanned by the vertical scanning section 34 is converted, by the lens system 38, so that the centerlines of beams of the scanned laser light become parallel to one another and form convergent laser beams. The laser light converted by the lens system 38 is converted by the lens system 39 so as to converge to a viewer's pupil 10a via a half mirror 15 included in the RSD 1. After passing through the second relay optical system 35, the laser light, which is the imagewise light Lx, is reflected by a half mirror 15 and is made to enter the viewer's pupil 10a. When the imagewise light Lx enters the pupil 10a, a display image in accordance with the image signal 5S is projected on the retina 10b. In this manner, the viewer recognizes the imagewise light Lx as a displayed image.

In the present embodiment, a configuration including the lens systems 38 and 39 and a half mirror 15 which constitute the second relay optical system 35 functions as an ocular optical system section; the ocular optical system section lets the laser light two-dimensionally scanned by the scanning section enter the pupil 10a of at least one of the viewer's eyes 10. The laser light entered the pupil 10a forms an image on the retina 10b through a crystalline lens of the eye to thereby display an image.

The half mirror 15 lets outside light Ly pass therethrough and enter the viewer's eyes 10. With this, the viewer recognizes the image in accordance with the imagewise light Lx as overlapping with a background recognized in accordance with the outside light Ly. As described above, the RSD 1 of the present embodiment is a see-through display which lets the imagewise light Lx emitted from the projection unit 3 be projected on viewer's eyes 10 and, at the same time, lets the outside light Ly pass therethrough. The RSD 1 may alternatively be an immersive display which lets only the imagewise light be projected on the user's eye without letting the outside light pass therethrough.

The thus-configured RSD 1 forms a head mounted display which is to be mounted on a viewer's head if the RSD 1 includes a support member which supports the configuration including the projection unit 3. The support member is, for example, an eyeglass frame and a goggle band. Note that the configuration including the projection unit 3 may be mounted on, for example, glasses and a helmet which a user already wears as a support member. Hereinafter, details of the RSD 1 of the present embodiment will be described.

### Operation of Scanning Section

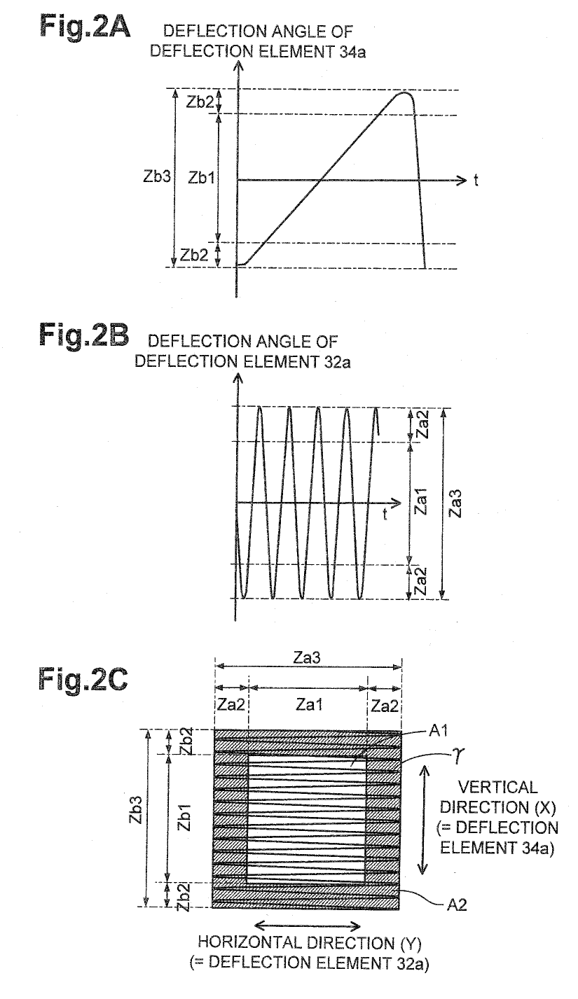

An operation of the scanning section included in the RSD 1 will be described with reference to FIGS. 1, 2A, 2B, and 2C. In the RSD 1, there exist a image area and an non-image area in each of the horizontal and vertical directions as scanning areas scanned with laser light by a scanning section. In the image area, an image is displayed in accordance with the image signal 5S. The non-image areas, in which image is not displayed, are located at both scanning direction sides of the image area. That is, as illustrated in FIG. 2A, non-image areas Za2 are located at both sides of the image area Za1 along the horizontal direction. The horizontal direction is the scanning direction of the horizontal scanning section 32 Similarly, a image area Zb1 and non-image areas Zb2 located at both sides of the image area Zb1 exist along the vertical direction as illustrated in FIG. 2B. The vertical direction is the scanning direction of the vertical scanning section 34. The image areas Za1 and Zb1 and the non-image areas Za2 and Zb2 are switched depending on a value of the modulated current supplied to the light source section 7.

The image areas Za1 and Zb1 are, in particular, the area in which laser light of which intensity is modulated in accordance with the image signal 5S is actually emitted from the light source section 7 (hereinafter, “laser light for image formation”) among the maximum areas Za3 and Zb3 which can be scanned with laser light by the deflection elements 32a and 34a of the horizontal scanning section 32 and the vertical scanning section 34, respectively (hereinafter, “maximum scanning area”). That is, the laser light for image formation is emitted at the timing at which the scanning positions of the deflection elements 32a and 34a of the scanning section are in the image areas Za1 and Zb1 which are defined as predetermined areas. The non-image areas Za2 and Zb2 in which no laser light for image formation is emitted among the maximum scanning areas Za3 and Zb3, are located on both sides of the image areas Za1 and Zb1 in the scanning direction of the laser light.

As illustrated in FIG. 2C, an image effective area A1 corresponding to the image areas Za1 and Zb1 and the image non-image area A2 (see shadow area) corresponding to the non-image areas Za2 and Zb2 are formed on the screen on which an image is formed by the laser light which is two-dimensionally scanned by the scanning section, as illustrated in FIG. 2. That is, the image effective area A1 is the display area of the image on the screen. In a case in which the scanning position of the laser light (hereinafter, “light scanning position”) is in the image effective area A1, the modulated current of the size in accordance with the image signal 5S is supplied to the light source section 7. Then the laser light for one frame is scanned by the horizontal scanning section 32 and by the vertical scanning section 34. This scanning is repeated for the image in each frame. In the present embodiment, as illustrated in FIG. 2, the image non-image area A2 is formed as a frame-shaped area which surrounds the rectangular-shaped image effective area A1.

Loci gamma of the laser light scanned by the horizontal scanning section 32 and by the vertical scanning section 34, assuming that the laser light is constantly emitted from the light source section 7, are illustrated in FIG. 2. Note that the reduced number of loci gamma are illustrated in FIG. 2 for the ease of illustration because the number of scanning events in the horizontal scanning direction (Y direction) by the horizontal scanning section 32 is about several hundreds to about one thousand for each frame. Regarding the scanning direction of the laser light by the scanning section, the horizontal direction which is the scanning direction of the horizontal scanning section 32 is the main-scanning direction and the vertical direction which is the scanning direction of the vertical scanning section 34 is the sub-scanning direction.

### Characteristics of Light Source Section

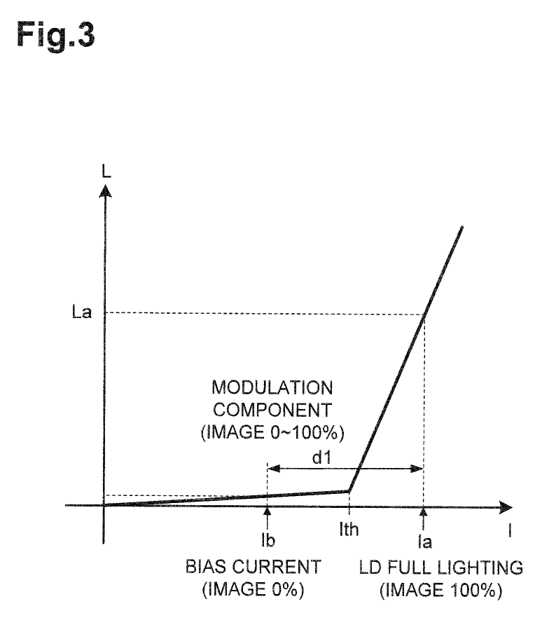

The characteristics of the lasers of each color 11a, 12a and 13a (hereinafter, “each laser”) of the light source section 7 will be described. In the graph illustrated in FIG. 3, the horizontal axis represents the current value (I) supplied to the laser and the vertical axis represents the light output (L) of the laser.

As illustrated in FIG. 3, the light output increases with the increase in the current value until the value of the current supplied to each laser reaches an inherent threshold current value Ith. When I<Ith, an increase in the light output is small and the light output itself is small. When the value of the current supplied to each laser exceeds the threshold current value Ith, the light output rises rapidly. As illustrated in FIG. 3, a relationship between the current value (I) of the laser and the light output (L) of the laser, namely current-light output characteristics, is called as IL characteristics.

Each of the lasers, which are semiconductor lasers, includes a capacity like a capacitor. Since a part of the current is used to charge the capacity in the process that the value of the current supplied increases from 0 to the threshold current value Ith, rising of the current which contributes actual emission is delayed accordingly. Thus each of the lasers requires a delay time before emitting light since each laser begins receiving supply of current. With such characteristics of the laser, a bias current of value Ib is supplied to each laser from the viewpoint of increase in response of the light source section 7 in the RSD 1 of the present embodiment. With the bias current (value Ib) being supplied, the laser is in the standby state and thereby the delay of emission is reduced. That is, the response of the light source section 7 is increased. In the RSD 1 of the present embodiment, the bias current value Ib is smaller than about half the value Ia of the current with which each laser is in a full lighting (with the light output La) (hereinafter, “maximum current”). In some cases, a value slightly smaller than the threshold current value Ith, for example, may be used as the bias current value.

The value of the current supplied to each laser falls within a range dl from the bias current value Ib to the maximum current value Ia. That is, the state of the bias current value Ib corresponds to the state in which image is 0% and the state of the maximum current value Ia corresponds to the state in which image is 100%. That is, the current range dl in which the image is 0 to 100% corresponds to the brightness range of the laser light as the modulation component in accordance with the image signal 5S. Accordingly, as illustrated in FIG. 3, the state in which the bias current of the value Ib is supplied to each laser is the black level. The current value range dl from the bias current value Ib to the maximum current value Ia is the modulation width of the modulated current supplied to each laser. Thus, the modulated current supplied to each laser changes within the range to the maximum current (image: 100%) in accordance with the image signal 5S with reference to the bias current which specifies the black level (image: 0%).

### Current Control

In the RSD 1 of the present embodiment, as the APC which automatically controls the optical output for the light output of each laser, APC which keeps the maximum value of the optical output of each laser at a predetermined value (hereinafter, “maximum value APC”) and APC which keeps the minimum value of the optical output of each laser at a predetermined value (hereinafter, “minimum value APC”) are performed. In the maximum value APC, the optical output is automatically controlled such that the light output (white level) of the laser in the state in which the image is 100% becomes a predetermined value. The maximum value APC is performed by controlling the bias current value. In the minimum value APC, the optical output is automatically controlled such that the light output (black level) of the laser in the state in which the image is 0% becomes a predetermined value. The minimum value APC is performed by adjusting the width of the current value range dl. Thus, if the maximum value APC and the minimum value APC are performed, the following phenomenon may occur since the laser has the IL characteristics as described above.

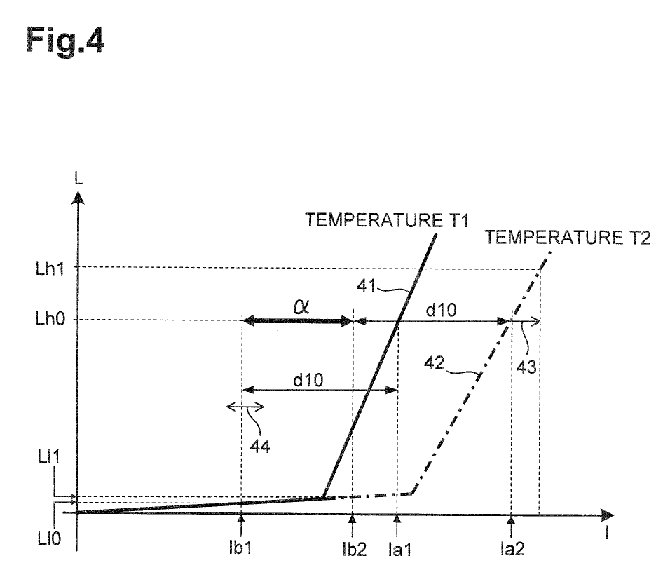

The IL characteristics of each laser change with the change in, for example, heat generated at the emission of the laser light and the change in the ambient temperature. For example, as illustrated in FIG. 4, when the laser temperature increases from T1 to T2, the IL characteristics shift from a curve 41 represented as a solid line to a curve 42 represented by a dash-dot line. That is, the threshold current value (see the value Ith in FIG. 3) increases as the laser temperature increases from T1 to T2.

Here, the white level value kept at the predetermined value in the maximum value APC is called as a value Lh0, and the black level value kept at the predetermined value in the minimum value APC is called as a value Ll0. In this case, in the state of temperature T1, the current of corresponding value Ia1 is supplied from the curve 41 to the value Lh0 of the white level as the maximum current, and the current of corresponding value Ib1 is supplied from the curve 41 to the value Ll0 of the black level as the bias current. In this case, the current value range d10 from the bias current value Ib1 to the maximum current value Ia1 becomes the modulation width of the modulated current.

In the maximum value APC, the maximum current is adjusted such that the white level value becomes the value Lh0 while keeping the modulation width d10 of the modulated current. That is, in the maximum value APC, the current supplied to the laser is controlled such that the white level value becomes the value Lh0 corresponding to the maximum current determined by the bias current value and the modulation width of the modulated current by adjusting the bias current value with reference to the IL characteristics of the laser. Accordingly, if the laser temperature changes from T1 to T2, in the maximum value APC, the bias current value is adjusted from the value Ib1 to the value Ib2 with reference to the IL characteristics at the temperature T2 represented by the curve 42. Thus, the value of the maximum current changes from the value Ia1 to the value Ia2 with the value Ib2 of the bias current and the modulation width d10.

Since the bias current value changes when the maximum value APC is performed, the black level value changes. As in this example, if the laser temperature increases from T1 to T2 as illustrated in FIG. 4, the bias current value increases from the value Ib1 to the value Ib2 in the maximum value APC, and thus the black level value increases from the value Ll0 to the value L11. The change in the black level value is caused by that a bias area in the IL characteristics of the laser is included in the modulation width of the modulated current and that the modulation width of the modulated current is fixed in the maximum value APC. Here, the bias area may be defined as an area on the side with a smaller current value in the IL characteristics with the threshold current (the value Ith in FIG. 3) as the starting point. The bias area is also called as an LED area.

Now, it is assumed that the black level which has been changed in the maximum value APC is adjusted to a predetermined value in the minimum value APC. In this case, in the minimum value APC, the modulation width of the modulated current is adjusted such that the black level value which has been changed to the value L11 from the value Ll0 becomes the value Ll0. That is, in the minimum value APC, the current supplied to the laser is controlled such that the black level value becomes the value Ll0 by adjusting the modulation width d10 of the modulated current with reference to the IL characteristics of the laser. However, if the minimum value APC is performed in this manner, a phenomenon in which the white level value adjusted in the maximum value APC changes occurs.

In particular, if the laser temperature increases from T1 to T2 as in this example, the bias current value is adjusted from the value Ib1 to the value Ib2 in order to keep the white level value at the predetermined value Lh0 in the maximum value APC as described above. The current amount actually supplied to the laser is an amount obtained by adding the bias current value to the modulated current. Therefore, if the minimum value APC is begun at a state in which the bias current value is value Ib2, the modulation width of the modulated current is adjusted in the direction to expand to the positive side (i.e., to the right in the graph of FIG. 4) from the bias current value Ib2 adjusted in the maximum value APC (see arrow 43). That is, even if the modulation width of the modulated current is adjusted in the minimum value APC, the bias current value is specified to the value Ib2 since the maximum value APC has already been performed. Therefore, the adjustment of the modulation width of the modulated current in the minimum value APC is performed not by decreasing the bias current value from the value Ib2 but by increasing the value of the maximum current value Ia2. Thus, if the modulation width of the modulated current expands in the positive side, the white level value increases exceeding the predetermined value Lh0 kept in the maximum value APC with the IL characteristics in the temperature T2 represented by the curve 42.

Assuming that the modulation width of the modulated current is adjusted to expand in the negative side (i.e., to the left in the graph of FIG. 4) from the maximum current value Ia2 which has been changed in the maximum value APC, both the white level value and the black level value are kept at predetermined values. Actually, however, since the bias current value is provided to the value Ib2 in the maximum value APC, the modulation width of the modulated current is adjusted to positive side from the bias current value Ib2, the white level value changes. In this example, in accordance with the increased amount of the modulation width represented by the arrow 43, the white level value increases from the value Lh0 to the value Lh1. Therefore, if minimum value APC is performed after the maximum value APC is performed, the bias current value is specified in the maximum value APC; a phenomenon occurs in which the maximum current value changes in the minimum value APC performed by adjustment of modulation width of the modulated current, and the white level changes with reference to the IL characteristics of the laser.

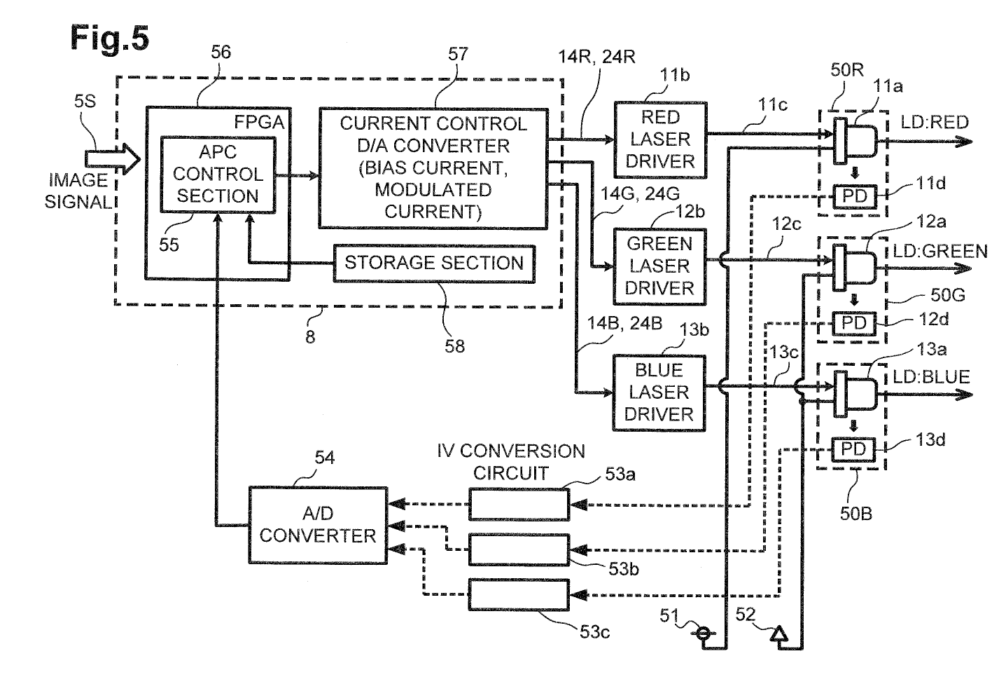

In the RSD 1 of the present embodiment, the current control described below is performed for the current supplied to each laser. First, a configuration of the RSD 1 of the present embodiment for performing the current control will be described with reference to FIG. 5.

### Configuration for Current Control

Optical output of each laser is detected in the current control in the RSD 1. Therefore, the RSD 1 includes monitoring photo diodes 11d, 12d and 13d for detecting the level of the optical output of the lasers of each color 11a, 12a and 13a as illustrated in FIG. 5.

In the RSD 1 of the present embodiment, laser modules 50R, 50G and 50B which includes the lasers 11a, 12a and 13a and the photo diodes 11d, 12d and 13d for each color of the laser light are formed. In the RSD 1 of the present embodiment, each of the photo diodes 11d, 12d and 13d constituting the laser modules of each color 50R, 50G and 50B functions as a light detecting section which detects the laser light emitted from the lasers of each color 11a, 12a and 13a in the current control in which the minimum value APC and the maximum value APC are performed.

Each of the photo diodes 11d, 12d and 13d detect the optical output of the lasers of each color 11a, 12a and 13a by, for example, receiving back light of the lasers of each color 11a, 12a and 13a. In the present embodiment, the red laser 11a is connected to the independent power supply 51 and the green laser 12a and the blue laser 13a are connected to a common power supply 52.

As illustrated in FIG. 5, the RSD 1 includes a current-voltage conversion circuit of each color (hereinafter, “IV conversion circuit”) 53a, 53b and 53c corresponding to the lasers of each color 11a, 12a and 13a, and an A/D converter 54. The IV conversion circuits 53a, 53b and 53c receive the current signal as a monitor signal from the photo diodes 11d, 12d and 13d which detect the optical output of the lasers of each color 11a, 12a and 13a, and then transform the received signal into a voltage signal. The voltage signal obtained by each of the IV conversion circuits 53a, 53b and 53c is input to the A/D converter 54. The IV conversion circuits 53a, 53b and 53c may be constituted by, for example, a transimpedance amplifier.

The A/D converter 54 converts an analog signal as the voltage signal received from each of the IV conversion circuits 53a, 53b and 53c into a digital signal. The digital signal obtained by the A/D converter 54 is input to the drive signal supply circuit 8. The drive signal supply circuit 8 includes an APC control section 55, a current control D/A converter 57, and a storage section 58. The current control D/A converter 57 processes the signal received from the A/D converter 54.

The APC control section 55 receives input of the signal from the A/D converter 54 including information about the optical output of the lasers of each color 11a, 12a and 13a, and generates a control signal for performing the minimum value APC and the maximum value APC for each color of the laser light in accordance with the input signal. In the present embodiment, the APC control section 55 is formed as a functional component of the Field Programmable Gate Array (FPGA) 56 in the drive signal supply circuit 8. The FPGA is an integrated circuit of which circuit can be rewritten in the field. However, the APC control section 55 may be formed by, for example, software in a microcomputer and other configurations, such as a dedicated IC circuit.

Schematically, the minimum value APC and the maximum value APC are performed as feedback control on the basis of comparison between the input signal from the A/D converter 54 and predetermined target values. The predetermined target values for the minimum value APC and the target value for the maximum value APC are stored in the storage section 58. The APC control section 55 accesses the storage section 58 to read the predetermined target values when the comparison is performed.

The target value of each of the minimum value APC and the maximum value APC is determined as a predetermined value, or is determined as a predetermined range which includes an upper limit and a lower limit. That is, the target value of each of the minimum value APC and the maximum value APC may be determined as a predetermined numerical value, or may be determined as a predetermined range of numerical value.

In particular, as described above, the APC control section 55 receives the laser light output detected by each of the photo diodes 11d, 12d and 13d as a voltage signal via each of the IV conversion circuit 53a, 53b and 53c and the A/D converter 54. Therefore, the target value of each of the minimum value APC and the maximum value APC determined in the APC control section 55 is determined as a voltage value corresponding to the laser light output.

According to the minimum value APC performed by the APC control section 55, the modulation width of the modulated current is adjusted such that the minimum value (black level) of the light output (hereinafter, “detected light output”) detected by each of the photo diodes 11d, 12d and 13d may become the predetermined target value with reference to the IL characteristics of each laser. Thus, in the present embodiment, the predetermined target value in the minimum value APC, which is stored in the storage section 50, corresponds to a first target value.

According to the maximum value APC similarly performed by the APC control section 55, with reference to the IL characteristics of each laser, the bias current is adjusted such that the maximum value (white level) of the detected light output becomes a predetermined target value. Thus, in the present embodiment, the predetermined target value in the maximum value APC, which is stored in the storage section 50, corresponds to a second target value.

The minimum value APC is performed by adjusting the modulation width of the modulated current as described above. The APC control section 55 generates a control signal for the modulated current as the control signal for the minimum value APC. The maximum value APC is performed by adjusting the bias current as described above. The APC control section 55 generates a control signal for the bias current as the control signal for the maximum value APC. The APC control section 55 generates a control signal for the minimum value APC and a control signal for the maximum value APC for each of the lasers of each color 11a, 12a and 13a.

The current control D/A converter 57 converts a digital signal as the control signal generated by the APC control section 55 into an analog signal. The current control D/A converter 57 converts the control signal for each modulated current and the bias current generated by the APC control section 55 as described above for each lasers of each color 11a, 12a and 13a. The current control D/A converter 57 includes a D/A converter for the bias current which converts the control signal for the bias current and a D/A converter for modulated current which converts the control signal for the modulated current.

The analog signal obtained by the current control D/A converter 57 is input to the laser driver 11b, 12b and 13b of corresponding color. The laser drivers 11b, 12b and 13b supply the current to the lasers of each color 11a, 12a and 13a via driving lines of each color 11c, 12c and 13c. As described above, the control signal generated by the APC control section 55 is converted by the current control D/A converter 57, and controls the current supplied to the lasers of each color 11a, 12a and 13a via each of the laser drivers 11b, 12b and 13b.

The current control in the RSD 1 of the present embodiment is performed by the configuration described above. Accordingly, in the present embodiment, the APC control section 55 functions as the current control section which controls the bias current supplied to the lasers of each color 11a, 12a and 13a and controls the modulated current which changes in accordance with the image signal 5S with reference to the bias current.

As the current control, the APC control section 55 performs the minimum value APC and then performs the maximum value APC. The APC control section 55 performs the minimum value APC and the maximum value APC in a state in which the light scanning position of the scanning section is in the non-image area which is outside the image area which forms a displayed image on the entire scanning areas of the laser light by the scanning section. Accordingly, the minimum value APC and the maximum value APC are performed, for example, for each frame of the displayed image in a state in which the light scanning position of the scanning section is in the non-image area Zb2 (see FIG. 2) about the sub-scanning direction (i.e., vertical direction).

The current control of the present embodiment will be described with reference to a case in which the laser temperature increases from T1 to T2, as illustrated in FIG. 4. In this case, the target value of the minimum value APC which is the first target value is set to the value Ll0 and, similarly, the target value of the maximum value APC which is the second target value is set to the value Lh0. That is, the modulation width of the modulated current is controlled such that the black level value becomes the value Ll0 in the minimum value APC. Similarly, the bias current is controlled such that the white level value becomes the value Lh0 in the maximum value APC.

In the current control of the present embodiment, minimum value APC is performed upon start-up of the RSD 1. In the minimum value APC, control is performed such that the black level value is kept at the value Ll0 corresponding to the change from the curve 41 to the curve 42 of the IL characteristics as the change in the laser temperature from T1 to T2. The minimum value APC controls the black level value by the adjustment of the modulated current supplied to the laser. Here, the modulation width d10 of the modulated current is adjusted to the value Lh0 which is specified by the curve 41 of the IL characteristics of the temperature T1 from the value Ia1 of the current corresponding to the target value of the white level (see arrow 44 in FIG. 4).

After the minimum value APC is performed, the maximum value APC is performed. According to the maximum value APC, in accordance with the modulation width of the modulated current adjusted in the minimum value APC, and IL characteristics of the laser at temperature T2 illustrated with curve 42, control that white level value is kept by value Lh0 is performed. The maximum value APC controls the white level value by adjusting the bias current supplied to the laser.

The control will be described in detail. Initial values of the modulated current and the bias current upon start-up of the RSD 1 will be referred to as the modulation width d10 of the modulation current and the bias current value Ib1, respectively. Upon start-up of the RSD 1, there is no change in the laser temperature and thus the IL characteristics do not change. Therefore, in accordance with the first minimum value APC after the starting up of the RSD 1, there is no change in the modulation width of the modulated current.

Next, the bias current is adjusted by performing the maximum value APC such that the white level value kept in the value Lh0. The adjustment of the bias current here is in response to temperature rise of the laser, thus the bias current is increased. Thus, the black level is increased. However, since the first maximum value APC upon start-up of the RSD 1 is corresponding thing at minute temperature change upon start-up of the RSD 1, increase in the black level here is minute change. Accordingly, there is a possibility that the first displayed image upon start-up of the RSD 1 is displayed in a state in which the black level has increased slightly, but such an increase in the black level can be ignored as a product.

The APC of the second time and afterwards, the laser temperature increases and the black level also increases. In the case of the present embodiment, the black level increases to the value L11 from the modulation width d10 of the modulated current and from the white level value Lh0. Then, in order to keep the black level value to the value Ll0, the modulation width d10 of the modulated current is adjusted. Actually, as illustrated in FIG. 4, in the state under the temperature T2, the modulation width of the modulated current is increased to d10+alpha and black level value is kept to the value Ll0.

As described above, brightness of the displayed image in a state in which the light output of the laser is at the black level is kept constant by the current control in which the maximum value APC is performed after the minimum value APC is performed. Since the maximum value APC is performed after the minimum value APC is performed, the white level is kept constant. That is, since the modulation width of the modulated current is adjusted previously as the maximum value APC is performed after the minimum value APC is performed, fluctuation in the white level is prevented.

As described above, in accordance with the RSD 1 of the present embodiment, changes in the black level can be reduced in the configuration in which the optical output is controlled automatically by adjusting the bias current supplied to each laser as the light source. Changes in the black level cause unstable brightness of the displayed image or reduced contrast in the image area. As a result, image quality of the displayed image is decreased. Then, controlling the changes in the black level can increase the image quality of the black level. An influence of the change in the black level on the brightness of the displayed image in the image area becomes small and thus a displayed image with stable brightness is obtained. As a result, an appropriate and stable image quality is achieved.

In the current control in the RSD 1 of the present embodiment, a light output corresponding to the bias area in the IL characteristics is used as the target value of the minimum value APC. Regarding the current value, as illustrated in FIG. 3, the IL characteristics of each laser includes a threshold current (Ith) specified as the current value of which light output increases rapidly as the current value increases in the process in which the current value increases. That is, regarding the current value, the IL characteristics of the laser is divided at the threshold current (Ith) into the bias area which is an area on the side with the lower current value, and an area on the side with higher current value. The target value of the minimum value APC is determined to the value of the light output corresponding to the current value of the value smaller than the threshold current (Ith). That is, the target value of the minimum value APC is determined to the value of the light output corresponding to the current value of the bias area within a range of changes considered about the IL characteristics which change due to, for example, changes in temperature.

As described above, the modulation width of the modulated current supplied to the laser can be increased because light output corresponding to the current value of the bias area in the IL characteristics is used as the target value of the minimum value APC. As a result, high contrast about the displayed image is achieved easily. Therefore, the image quality can be effectively increased by reducing the change in the black level.

### Control Flow of Current Control

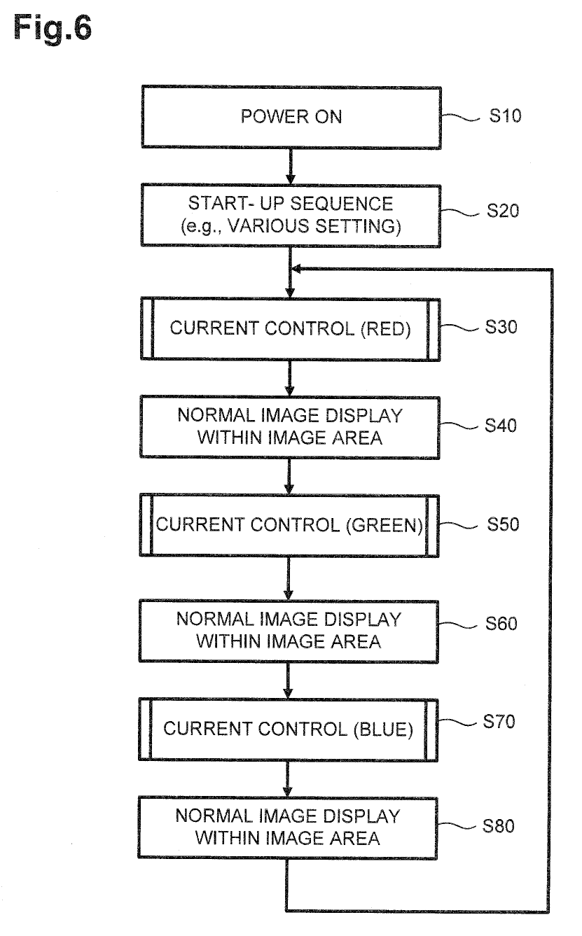

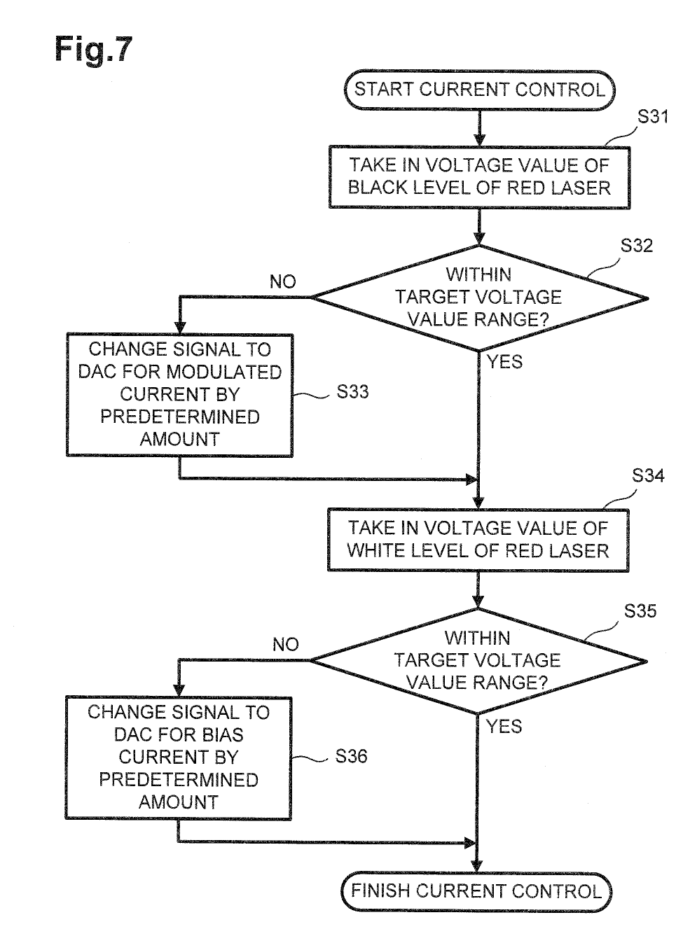

An example of a series of the control flow including the current control in the RSD 1 of the present embodiment will be described with reference to the flowchart illustrated in FIGS. 6 and 7. As illustrated in FIG. 6, the RSD 1 is powered on (S10). Upon start-up of the RSD 1, a start-up sequence in which, for example, various setting about the operation of each section of the RSD 1 or the like is performed in the controller 5 (S20).

After the start-up sequence is performed, the current control is performed to sequentially perform the minimum value APC and the maximum value APC. In the control operation of this example, the current control about each laser is performed for each frame of the displayed image in red, green and blue in this order.

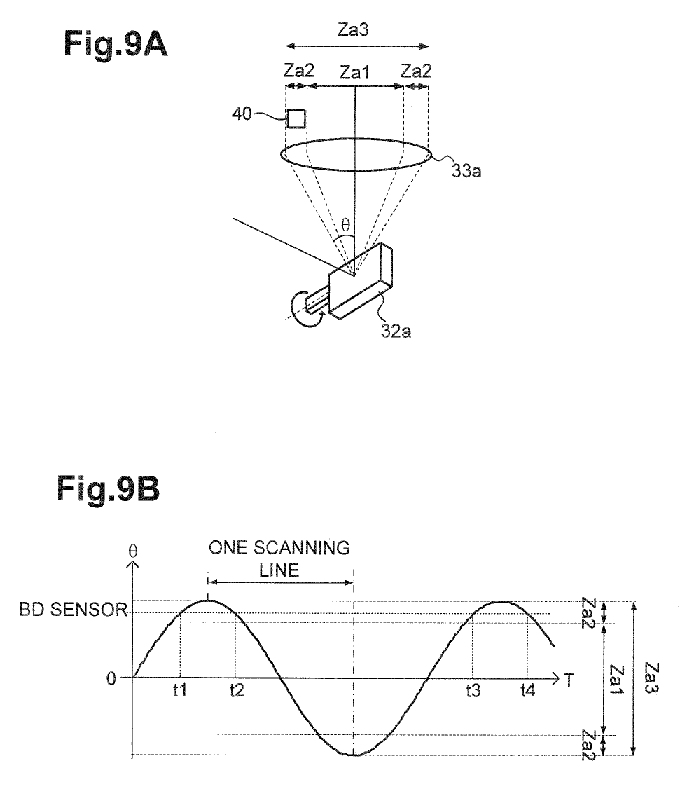

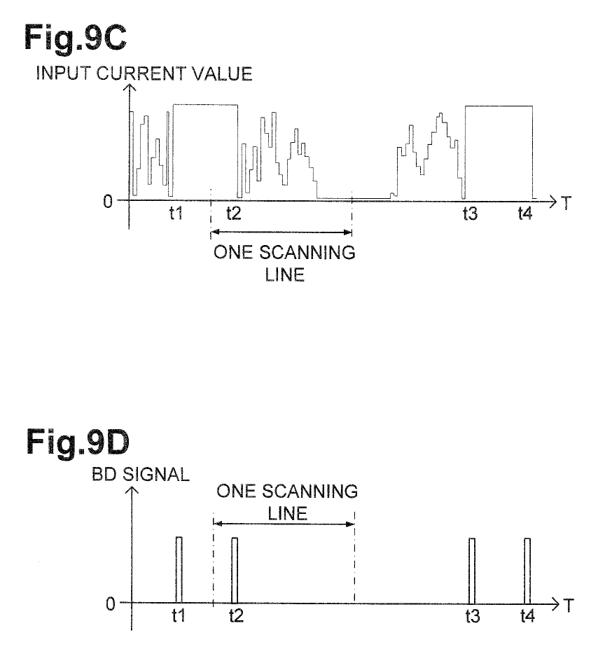

The current control is performed in each frame in a state in which the light scanning position is in the non-image area Zb2 (see FIG. 2) before entering the image area Zb1 (see FIG. 2) along the sub-scanning direction. Accordingly, in the RSD 1, in order to determine the scanning position, the scanning line of the laser light in the main-scanning direction is counted. Specifically, the counting of the scanning lines is achieved by counting a number of BD signals 41 from the BD sensor 40 to a driving signal supply circuit 8. Since the BD sensor 40 is displaced in the first relay optical system 33, the scanning position cross the BD sensor 40 once in each scanning line (FIGS. 9A and 9b). Input current value to the lasers of each color 11a, 12a and 13a is maintained a constant value between timing t1 and t2 where the scanning position is within the non-image area (FIG. 9C). Thus, the BD sensor 40 generates one BD signal 41 in each scanning line in the main-scanning direction (FIG. 9D). The sizes of the image area and the non-image area, i.e., the number of the scanning lines therein, can be preset in the storage section 58 in the factory. Thus, the scanning position can be determined by counting the number of the BD signals 41. If the scanning line is in the non-image area before entering the image area along the sub-scanning direction, the current control is performed. For example, in a case in which 100 scanning lines at both sub-scanning direction sides among 1000 scanning lines correspond to the invalid scanning area Zb2 and the 800 scanning lines correspond to the image area Zb1, the current is controlled when the light scanning position is in the 100 scanning lines on the near side along the sub-scanning direction.

Accordingly, as illustrated in FIG. 6, scanning with laser light is begun at a certain frame, current control for the red laser 11a is performed in a state in which the light scanning position is in the invalid scanning area along the sub-scanning direction (S30). In the frame for which the current control has been performed, a normal image display in accordance with the image signal 5S is performed when the light scanning position reaches the image area along the sub-scanning direction (S40).

Similarly, after the current control for the green laser 12a is performed in the next frame (S50), a normal display in the image area of the frame is performed (S60). After the current control for the blue laser 13a is performed in the next frame (S70), a normal display in the image area of the frame is performed (S80). In this manner, the processes (S30 to S80) of current control about the lasers 11a, 12a and 13a of three colors and the normal image display are repeated for every three frames.

The current control (S30, S50 and S70 of FIG. 6) of each laser will be described with reference to the flowchart illustrated in FIG. 7. Since the processes common to the lasers of three colors are employed in the current control of each laser, the current control (S30 of FIG. 6) of the red laser 11a will be described as an example. The process of the current control as illustrated in FIG. 7 is performed by the APC control section 55 included in the RSD 1.

As illustrated in FIG. 7, in the current control of this example, the voltage value of the black level of the photo diode (PD) 11d of the red laser (LD) 11a is taken first (S31). That is, the red laser driver 11b supplies the red laser 11a with the bias current in accordance with the bias current supply signals 24R. Then, the optical output of the red laser 11a detected by the photo diode 11d for red color is taken in the APC control section 55 as a voltage signal of the digital signal via the IV conversion circuit 53a and the A/D converter 54 (see FIG. 5). This corresponds to the black level the LD 11a.

Next, it is determined by the APC control section 55 whether the taken voltage value of the black level is within the target voltage value range (S32). That is, the predetermined target voltage value range about the voltage value of the black level is previously set and stored in advance in the APC control section 55, and it is determined whether the voltage value of the black level is in the target voltage value range by comparing the upper limit and the lower limit which specify the target voltage value range and the taken voltage value in the black level. If the taken voltage value of the black level is within the target voltage value range (S32: YES), the process proceeds to step S34.

If the taken voltage value of the black level is not within the target voltage value range (S32: NO), the APC control section 55 changes the signal to the D/A converter (DAC) for modulated current, included in the current control D/A converter, 57 by a predetermined amount (S33). The control signal with respect to the red laser 11a from the APC control section 55 is converted into the digital signal by the current control D/A converter 57 and is input to the red laser driver 11b. With this, the amount of the current supplied to the laser 11a is changed and thereby the light output of the laser 11a is changed since the signal input to the current control D/A converter 57 from the APC control section 55 is changed.

That is, the target voltage value range about the voltage value of the black level is determined in correspondence with the target value (first target value) about the black level value. If the voltage value of the black level is not within the target voltage value range, the signal to the current control D/A converter 57 is made to change by a predetermined amount such that the black level approaches the first target value.

The signal to the current control D/A converter 57 which is made to change by a predetermined amount in step S33 is a signal to the converting function for the modulated current included in the current control D/A converter 57. Accordingly, in step S33, the modulation width of the modulated current supplied to the laser 11a is changed in correspondence with the predetermined amount about an amount of change of the signal from the APC control section 55 to the current control D/A converter 57. With this, the black level value approaches or agrees with the predetermined first target value.

As the predetermined amount for the signal to the current control D/A converter 57 which is changed in step S33, for example, a unit amount corresponding to a least significant bit of the current control D/A converter 57 is used. However, an integral multiple of the unit amount may be used as the predetermined amount for the signal to the current control D/A converter 57. After the signal to the current control D/A converter 57 is changed in step S33, the process proceeds to step S34.

The processes of steps S31 to S33 correspond to the minimum value APC performed in the current control. In this example, the target value (first target value) of the minimum value APC is determined as the predetermined range of numerical value corresponding to the target voltage value range about the voltage value of the black level.

After step S32 or step S33 is performed, the voltage value of the white level of the photo diode 11d of the red laser 11a is taken in (S34). That is, as described above, the white level of the optical output of the red laser 11a detected by the photo diode 11d for red is taken into the APC control section 55 as the voltage signal of the digital signal via the IV conversion circuit 53a and the A/D converter 54 (see FIG. 5).

Next, it is determined whether the voltage value of the taken white level is within the target voltage value range by the APC control section 55 (S35). In the APC control section 55, a predetermined target voltage value range about the voltage value of the white level is set and stored in advance. The upper limit and the lower limit which specify the target voltage value range and the voltage value of the taken white level is compared to determine whether the voltage value of the white level is in the target voltage value range. If the voltage value of the taken white level is within the target voltage value range (S35: YES), the process of the current control is terminated.

If voltage value of the taken white level is not within the target voltage value range (S35: NO), the APC control section 55 changes the signal to the D/A converter (DAC) for the bias current, included in the current control D/A converter 57 (S36), by a predetermined amount. That is, the target voltage value range about the voltage value of the white level is determined in correspondence with the target value (second target value) about the white level value. If the voltage value of the white level is not within the target voltage value range, the signal to the current control D/A converter 57 is made to change by a predetermined amount so that the white level approaches the second target value.

The signal to the current control D/A converter 57 which is made to change by a predetermined amount in step S36 is the signal to the converting function for the bias current included in the current control D/A converter 57. Accordingly, in step S36, the bias current supplied to the laser 11a is changed in correspondence with a predetermined amount about the amount of change of a signal from the APC control section 55 to the current control D/A converter 57. With this, the white level value approaches or agrees with the predetermined second target value.

The predetermined amount about the signal to the current control D/A converter 57 changed in step S36 is determined similarly to the predetermined amount in step S33. After the signal to the current control D/A converter 57 is changed in step S36, the process of the current control completes.

The processes of above steps S34 to S36 correspond to the maximum value APC performed in the current control. In this example, the target value (second target value) of the maximum value APC is determined as predetermined range of numerical value corresponding to target voltage value range about the voltage value of the white level.

The above-described current control is performed for the green laser 12a in step S50 and for the blue laser 13a in step S70 in a similar manner as for the red laser 11a. The timing and the order of the current control of the lasers of each color 11a, 12a and 13a is not limited to that illustrated in the flowchart of FIG. 6.

In the example illustrated in FIG. 6, the current control of each laser is performed in a state in which the light scanning position is in the invalid scanning area before entering the image area along the sub-scanning direction in each frame. This is not restrictive: for example, the current control may be performed along the sub-scanning direction in a state in which the light scanning position is in the invalid scanning area after leaving the image area or in a state in which the light scanning position is in the invalid scanning areas on both sides of the image area. The current control of the laser of different color may be performed in the invalid scanning areas on both sides of the image area along the sub-scanning direction in one frame.

If the current control of each laser is performed for each frame as illustrated in FIG. 6, it is possible that there are some frames for which no current control of each laser is performed. For example, in this case, every four frames are repeated: the frame subject to the current control of the red laser 11a, the frame subject to the current control of the green laser 12a, the frame subject to the current control of the blue laser 13a and the frame subject to no current control.

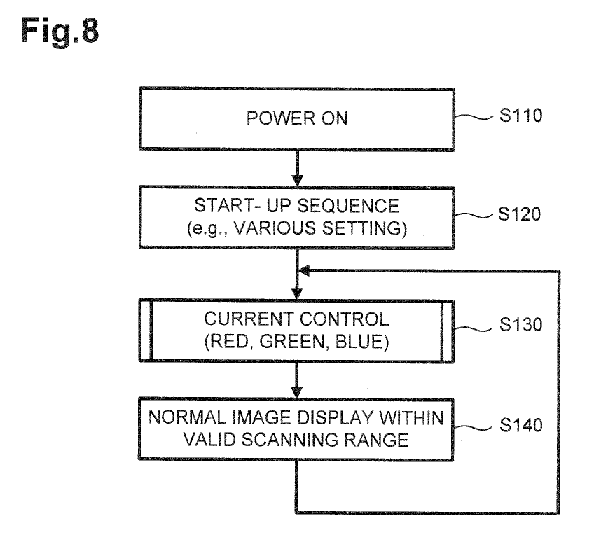

The current control of each of the lasers may be performed simultaneously. An example of the control flow of a case in which current control of each of the lasers is performed simultaneously is illustrated in FIG. 8. In this case, as illustrated in FIG. 8, the RSD 1 is powered on (S110) and the start-up sequence is performed (S120), the current control of three color lasers 11a, 12a and 13a is performed simultaneously (S130).

The current control of three colors is performed in the following manner: in a state in which the light scanning position is in the invalid scanning area before entering the image area along the sub-scanning direction, the current control as illustrated in FIG. 7 is performed in parallel by the lasers of three colors. After the simultaneous current control of three colors is performed, a normal display in the image area of the frame subject to the current control is performed (S140). In this manner, the processes (S130, S140) of simultaneous current control of the three colors and the normal image display are repeated for each frame.

Thus, the simultaneous current control of the lasers of three colors eliminates a difference in current control of the laser due to different colors of the lasers, whereby more stable image quality is achieved.

Preferably, the current control of the lasers of each color 11a, 12a and 13a is performed in the descending order from the color with visibility (i.e., relative luminous efficiency). In particular, the APC control section 55 performs the current control of the lasers of each color 11a, 12a and 13a in the descending order of visibility of color of the laser light emitted by the laser.

Among the red, green and blue which the RSD 1 of the present embodiment has as the color of the laser light, green has the highest visibility and blue has the lowest visibility. Accordingly, if the current control is performed in the descending order with visibility of the color of the laser light in the RSD 1 of the present embodiment, the current control is performed in the order of the green laser 12a, the red laser 11a and the blue laser 13a.

The case in which the current control is performed in the descending order of visibility of color of the laser light will be described with reference to FIG. 6. In S30, current control for green is performed instead of red. In S50, current control for red is performed instead of green. In S70, current control for blue is performed. As described above, regarding the lasers 11a, 12a and 13a of three color, the current control is performed in the descending order of color with a greater influence due to changes in the light output in the displayed image recognized by the viewer of the RSD 1 by performing the current control in the descending order of visibility of the color of the laser light to be emitted. With this, the image quality is effectively increased by reducing the change in the black level.

### Modification of Current Control

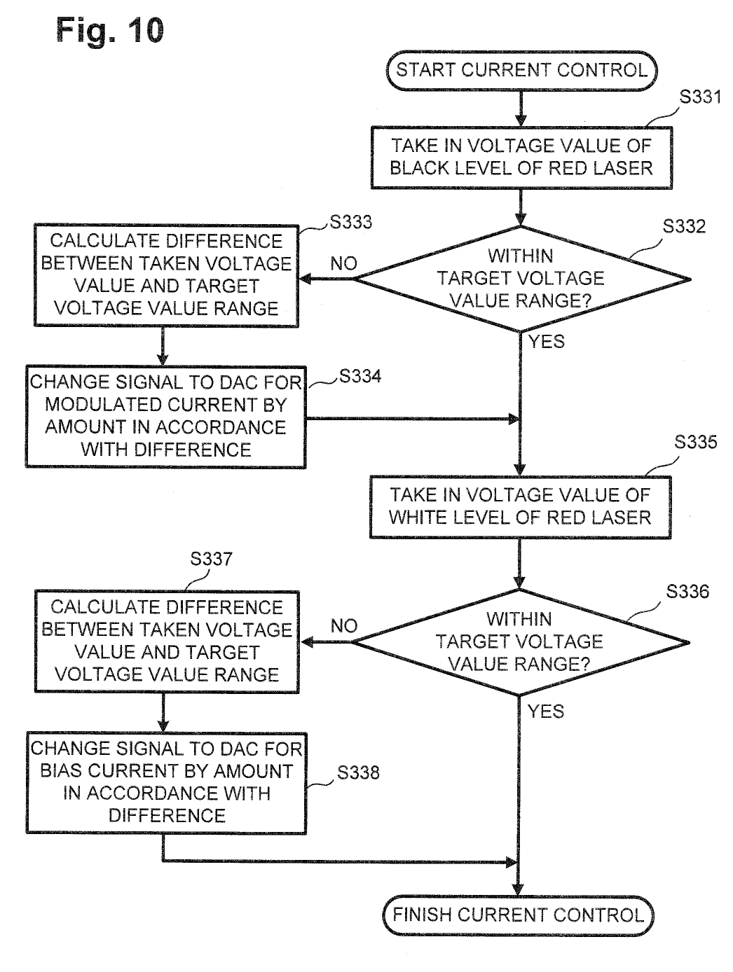

A modification of the current control will be described. In the current control of this example, a control amount of the current value is changed in the minimum value APC and the maximum value APC in accordance with (e.g., proportional to) the size of difference between the value of the detected light output and the target value. That is, regarding the minimum value APC, the APC control section 55 performs the control to let the adjustment amount of the modulation width of the modulated current be changed in accordance with the size of difference between the minimum value (black level) of the detected light output and the target value (first target value) of the minimum value APC. Regarding the maximum value APC, the APC control section 55 performs the control to let the adjustment amount of the bias current be changed in accordance with the size of difference between the maximum value (white level) of the detected light output and the target value (second target value) of the maximum value APC. This is explained with reference to FIG. 10.

In step S331, the voltage value of the black level of the photo diode 11d of the red laser 11a is taken first, as well as the step S31 in FIG. 6.

In step S332, it is determined by the APC control section 55 whether the taken voltage value of the black level is within the target voltage value range, as well as step S32 in FIG. 6.

In step S333, a difference between the taken voltage value and the target voltage value range is calculated. That is, if the taken voltage value is larger than the upper limit of the target voltage value range, the difference between the upper limit and the taken voltage value is calculated. If the taken voltage value is smaller than the lower limit of the target voltage value range, the difference between the lower limit and the taken voltage value is calculated.

In step S334, the APC control section 55 performs the minimum value APC. That is, the APC control section 55 changes the signal to a D/A converter (DAC) for the modulated current by an amount in accordance with the difference calculated in step S333. That is, in accordance with the calculated difference, the APC control section 55 changes the signal transmitted to the current control D/A converter 57 such that the voltage value as the detected light output falls within the target voltage value range. The target voltage value range about the voltage value of the black level is determined in correspondence with the target value (first target value) for the black level value. Then, if the taken voltage value is not within the target voltage value range, the signal to the current control D/A converter 57 is made to change such that the taken voltage value is within the target voltage value range in accordance with the size of difference between the taken voltage value and the target voltage value range.

Accordingly, in step S334, the modulation width of the modulated current supplied to the laser 11a changes to set the voltage value as the detected light output as the target voltage value range in accordance with the calculated difference. With this, the black level value is set to the predetermined first target value.

In step S335, the voltage value of the white level of the photo diode 11d of the red laser 11a is taken in, as well as step S34 in FIG. 6.

In step S336, it is determined whether the voltage value of the taken white level is within the target voltage value range by the APC control section 55, as well as step S35 in FIG. 6.

In step S337, the APC control section 55 calculates the difference between the taken voltage value and the target voltage value range.

In step S338, the APC control section 55 performs the maximum value APC. That is, the APC control section 55 changes the signal to the D/A converter (DAC) for the bias current change by an amount corresponding to the difference calculated in step S338. That is, in accordance with the calculated difference, the APC control section 55 changes the signal to be transmitted to the current control D/A converter 57 such that the voltage value as the detected light output is within the target voltage value range.

The target voltage value range about the voltage value of the white level is determined in correspondence with the target value (second target value) about the white level value. Then, if the taken voltage value is not within the target voltage value range, the signal to the current control D/A converter 57 is changed such that the taken voltage value is within the target voltage value range in accordance with the size of difference between the taken voltage value and the target voltage value range.

The signal to the current control D/A converter 57 which is changed by the predetermined amount in step S338 is a signal to the converting function for the bias current included in the current control D/A converter 57. Accordingly, in step S338, in accordance with the calculated difference, the bias current supplied to the laser 11a changes to set the voltage value as the detected light output as the target voltage value range. With this, the white level value is set to the predetermined second target value.

In the modification of the current control in FIG. 10, the minimum value APC adjusts the amount of the modulation width of the modulated current in accordance with the difference between the minimum value (black level) of the detected light output and the target value (first target value) of the minimum value APC. The maximum value APC adjusts the amount of the bias current in accordance with the difference between the maximum value (white level) of the detected light output and the target value (second target value) of the maximum value APC. It is also possible that only the minimum value APC is performed. Further, the maximum value APC may be performed before the minimum value APC is performed.

Since the amount of control is adjusted in accordance with the difference between the detected light output and the target value in the current control, the current control adapted to the actual changes in the IL characteristics of the laser caused by, for example, a temperature change is achieved. With this, the change in the black level can be reduced effectively and thus more stable image quality is achieved.

In the RSD 1 of the present embodiment, the maximum value APC which specifies the maximum value of the optical output of the laser of each color and the minimum value APC which specifies minimum value of the optical output of the laser of each color are performed. The minimum value APC and the maximum value APC are performed in the non-image area in this order. In the current control in the RSD 1 of the present embodiment, the relative timing at which the maximum value APC and the minimum value APC are performed is important from the viewpoint of stabilizing image quality. Thus, the current control in the RSD 1 of the present embodiment lets the maximum value APC and the minimum value APC be performed at a predetermined timing to control the bias current and the modulated current.

In the RSD 1 of the present embodiment, the maximum value APC and the minimum value APC are performed when the scanning line is in the non-image area because image data are displayed when the scanning line is in the image area. However, the maximum value APC and the minimum value APC may be performed when the scanning line is in the image area. For example, during the start-up sequence of the RSD 1 (S20 of FIG. 6), the image data are not displayed. Thus, during the start-up sequence, the maximum value APC and the minimum value APC may be performed when the scanning line is in the image area.

In the RSD 1 of the present embodiment, the photo diodes 11d, 12d and 13d provided to correspond to the lasers of each color 11a, 12a and 13a as the light detecting section for detecting the laser light output to perform the current control; but this is not restrictive. The light detecting section may be the existing light detecting section included in the RSD 1 or may be a light detecting section separately provided to perform current control.

As an example of existing configuration included in the RSD 1, a BD sensor 40 included in the RSD 1 in the first relay optical system 33 as described above may be used. In this case, the light output of each laser is detected in accordance with the laser light for timing detection to be detected by the BD sensor 40. Then, a configuration in which the BD signal 41 output from the BD sensor 40 is converted into a voltage signal by the IV conversion circuit and is converted into a digital signal by the A/D converter and is input to the APC control section 55 is employed.

The RSD 1 of the present embodiment includes three lasers 11a, 12a and 13a which emits laser light of each color of red, green and blue as the light source which emits laser light of mutually different color, this is not restrictive. The light source which emits laser light of mutually different color may be two, four and more lasers.

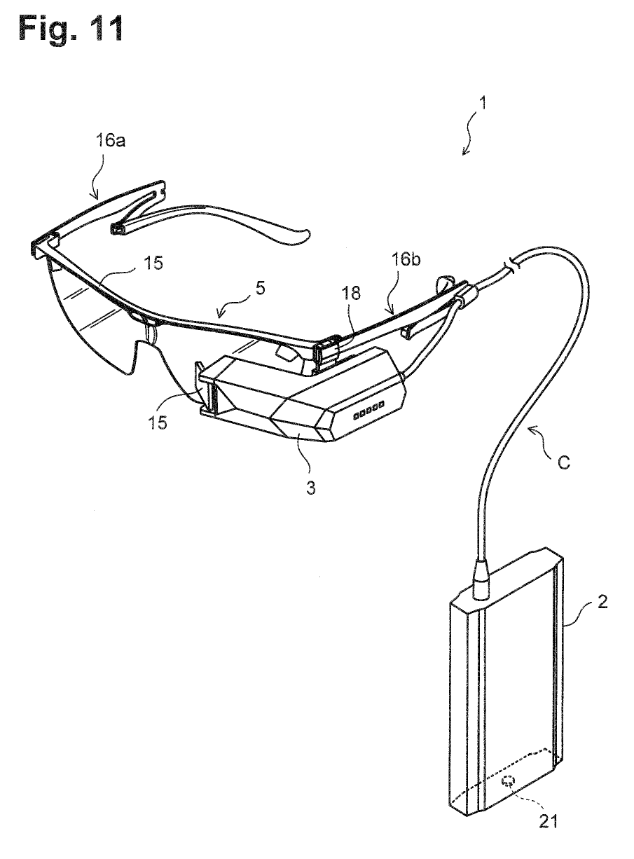

The RSD 1 can be used as a head mounted display as shown in FIG. 11. The RSD 1 includes the control unit 2, a transmission cable C, the projection unit 3, and a spectacle-type frame 5. The transmission cable C includes an optical fiber 4 and signal lines (see FIG. 1). The projection unit 3 is configured to be attached on the spectacle-type frame 5 through an attachment 18. Specifically, the projection unit 3 is mounted to the left side (as viewed from the user) of the spectacle-type frame 5 in FIG. 11.

The spectacle-type frame 5 is configured to be mounted on a head of a user similarly to a pair of general spectacles. The half mirror 15, which is a part of the ocular optical system section, is disposed at a distal end of the projection unit 3. When the spectacle-type frame 5 is mounted on the head of the user, the half mirror 15 is displaced in front of an eye of the user. Thus the user can see the image superimposed on an exterior sight.

Further, the spectacle-type frame 5 includes a front portion 15 and two temple portions 16a and 16b on the right and left sides, respectively. The temple portions 16a and 16b have a Z-shape structure in their intermediate portions. This Z-shape structure allows the temple portions 16a and 16b to bend flexibly.

As described above, with the RSD 1 according to the present embodiment, the following effects can be expected.

(1) The RSD 1 of the present embodiment includes the light source section 7, the scanning section, the photo diodes 11d, 12d and 13d and the APC control section 55. The light source section 7 includes the lasers 11a, 12a and 13a which emit laser light of intensity in accordance with the image signal 5S. The scanning section two-dimensionally scans the laser light emitted from the light source section 7. The photo diodes 11d, 12d and 13d detect the laser light emitted from the lasers of each color 11a, 12a and 13a. The APC control section 55 controls the bias current supplied to each laser and the modulated current which changes in accordance with the image signal 5S with reference to the bias current in accordance with the detected light output. The APC control section 55 performs, in a state in which the scanning position of the laser light is in the invalid scanning area, the current control to adjust the modulation width of the modulated current such that the minimum value (black level) of the detected light output becomes the predetermined first target value and, then, adjust the bias current such that the maximum value (white level) of the detected light output becomes the predetermined second target value in accordance with the IL characteristics of each laser. With this, it is possible to reduce the change in the black level and thereby an appropriate and stable image quality is achieved in a configuration in which the optical output is automatically controlled by the adjustment of the bias current supplied to each laser.

(2) In the RSD 1 of the present embodiment, regarding the current value, the IL characteristics include the threshold current (Ith) specified as the current value of which the light output accompanying the increase in the current value increases rapidly in the course of the current value increases. First target value is determined as the current value of value smaller than threshold current (Ith) at value of corresponding light output. With this, since it becomes easy to increase the modulation width of the modulated current supplied to each laser and high contrast about the displayed image is achieved easily, image quality is increased effectively by reducing the change in the black level.

(3) In the RSD 1 of the present embodiment, the light source section 7 includes three lasers 11a, 12a and 13a each of which emits laser light of mutually different color. The APC control section 55 performs current control of each of the three lasers in the descending order of high visibility of color of the laser light emitted by each laser. With this, in the displayed image which the viewer of the RSD 1 recognizes, the current control is performed in the descending order of color with greater influence by the change of the light output. Therefore, image quality can be increased effectively by reducing the change in the black level.

(4) In the RSD 1 of the present embodiment, the APC control section 55 controls at least one of the first adjustment amount control and the second adjustment amount control. In the first adjustment amount control, the adjustment amount of the modulation width of the modulated current changes in accordance with the size of difference between the minimum value (black level) of the detected light output and the first target value. In the second adjustment amount control, the adjustment amount of the bias current changes in accordance with the size of difference between the maximum value (white level) of the detected light output and the second target value. With this, current control in accordance with the actual condition of change of the IL characteristics of the laser caused by the temperature change or the like can be performed. Therefore, image quality can be increased effectively by reducing the change in the black level and more stable image quality is achieved.

(5) The RSD 1 of the present embodiment further includes the ocular optical system section which lets laser light which has been two-dimensionally scanned by the scanning section enter the retina 10b of at least one of the eyes 10 of the viewer. The ocular optical system section lets an image be displayed with the retina 10b being the projection target of the laser light. With this, the current control is performed in a configuration in which changes in the black level is relatively easy to recognize by the user. Therefore, image quality can be increased effectively by reducing the change in the black level.

What is claimed is:

1. A scanning image display device comprising:
a laser source configured to emit laser light;
a scanning section configured to scan the laser light within a scanning area;
a light detecting section configured to detect the laser light; and
a current control section configured to control a bias current which is supplied to the laser source based on the laser light detected by the light detecting section and a modulated current which changes in accordance with an image signal and to adjust a modulation width of the modulated current to set a minimum value of the laser light emitted by the light source as a first target value.

2. The scanning image display device according to claim 1 wherein,
the current control section is further configured to adjust the bias current to set a maximum value of the laser light emitted by the laser source as a second target value.

3. The scanning image display device according to claim 2 wherein,
the current control section configured to adjust the bias current after the adjustment of the modulation width.

4. The scanning image display device according to claim 1 wherein,
the current control section further comprising:
a storage section configured to store at least the first target value being a value of the laser light corresponding to a current value which is smaller than a threshold current, the threshold current is based on a current-light output characteristics of the laser source and is a current value at which the laser light emitted increases precipitously as the current value increases.

5. The scanning image display device according to claim 1, wherein
the laser source includes a plurality of semiconductor lasers, the plurality of semiconductor lasers emit laser light of different color each other, and
the current control section adjusts the modulation width of the modulated current of each of the plurality of the semiconductor lasers in a descending order of visibility of color of the laser light emitted from each the semiconductor laser.

6. The scanning image display device according to claim 1, wherein
the laser source includes a plurality of semiconductor lasers, the plurality of semiconductor lasers emit laser light of different color each other, and
the current control section controls current of each of the plurality of the semiconductor lasers simultaneously.

7. The scanning image display device according to claim 1 wherein,
the current control section is further configured to supply a predetermined value current to the laser source, and
the light detecting section is further configured to detect the laser light emitted from the laser source when the predetermined value current is supplied to the laser source.

8. The scanning image display device according to claim 7 wherein,
the predetermined value current is the bias current, and
the current control section adjusts the modulation width based on a difference between the first target value and the laser light detected by the light detecting section when the bias current is supplied to the laser source.

9. The scanning image display device according to claim 8 wherein,
the current control section adjusts the modulation width by an amount determined based on a magnitude of a difference between the first target value and the laser light detected by the light detecting section.

10. The scanning image display device according to claim 8 wherein,
the current control section adjusts the modulation width by a predetermined amount.

11. The scanning image display device according to claim 7 wherein,
the current control section is further configured to adjust the bias current to set a maximum value of the laser light output detected by the light detecting section as a second target value,
the predetermined value current is a maximum current, the maximum current corresponds to the maximum value of the laser light, and
the current control section is further configured to adjust the bias current based on a difference between the second target value and the light output of the laser source when the maximum current is supplied to the laser source.

12. The scanning image display device according to claim 11 wherein,
the current control section adjusts the bias current by an amount determined based on a magnitude of a difference between the second target value and the laser light detected by the light detecting section.

13. The scanning image display device according to claim 11 wherein,
the current control section adjusts the bias current by a predetermined amount.

14. The scanning image display device according to claim 1 further comprising:
a determination section configured to determine whether a scanning position of the laser light is within an image area in which a displayed image is formed within the scanning area, wherein
the current control section configured to adjust the modulation width when the scanning position is outside the image area.

15. The scanning image display device according to claim 14 wherein,
the determination section comprises:
a position detector configured to detect the scanning position by receiving the laser light; and
a position determination circuit configured to:
receive input from the position detector; and
determine whether the scanning position is within the image area based on the input.

16. The scanning image display device according to claim 15 wherein,
the scanning section comprises a first scanner configured to scan the laser light in a main-scanning direction and a second scanner configured to scan the laser light in a sub-scanning direction slower than the first scanner, the sub-scanning direction is perpendicular to the main-scanning direction, and
the current control section adjusts the modulation width of the modulated current when the scanning position is outside the image area in the sub-scanning direction.

17. The scanning image display device according to claim 16 wherein,
the current control section adjusts the modulation width of the modulated current when the scanning position is outside and prior to the image area in the sub-scanning direction.

18. The scanning image display device according to claim 1, further comprising:
an ocular optical system section which lets laser light scanned by the scanning section enter a retina of at least one of eyes of a viewer.

19. The scanning image display device according to claim 18, further comprising:
a frame configured to be mounted on a head of a user, wherein the ocular optical system section is configured to attach the frame.

20. A method of controlling a current supplied to a laser source configured to emit laser light in a scanning image display device comprising:
detecting the laser light;
adjusting a modulation width of a modulated current to set a minimum value of the laser light emitted from the laser source as a first target value, the modulated current changes in accordance with an image signal; and
controlling a bias current and the modulated current, the modulated current has the adjusted modulation width, and the bias current is supplied to the laser source based on laser light detected.

21. A scanning image display device comprising:
a laser source configured to emit laser light;
a scanner configured to scan the laser light within a scanning area;
a light detector configured to detect the laser light;
a memory configured to store computer readable programs; and
a processor configured to execute the computer readable programs to provide:
an adjustment unit configured to adjust a modulation width of a modulated current to set a minimum value of the laser light emitted from the laser source as a first target value, the modulated current changes in accordance with an image signal; and
a current control unit configured to control a bias current and the modulated current, the modulated current has the modulation width adjusted by the adjustment unit, and the bias current is supplied to the laser source based on laser light output detected by the light detector.
